(19) United States
(12) Patent Application Publication
(10) Pub. No.: US 2016/0193665 A1
(43) Pub. Date: Jul. 7, 2016

(54) CLAMPING DEVICE

(71) Applicant: MTH GbR Markus und Thomas Hiestand, Pfullendorf (DE)

(72) Inventor: Karl Hiestand, Pfullendorf (DE)

(21) Appl. No.: 14/987,852

(22) Filed: Jan. 5, 2016

(30) Foreign Application Priority Data
Jan. 5, 2015 (EP) 15 150 064.2

(51) Int. Cl. B23B 31/26; B23Q 3/12

(52) U.S. Cl. CPC B23B 31/26; B23Q 3/12; B23B 2231/24; B23B 2231/26; B23B 2231/42

(57) ABSTRACT

A clamping device (1) for machine tools (2), equipped with a power-operated chuck (5) and an electric drive motor (11) with a changeover function for triggering clamping movements, a motion converter (31) for converting the adjustment movements into the axial movements of a draw rod (7) as well as a force accumulator (41), is configured as a play and slip-free functional unit, and to determine the axial adjustment movements of the draw rod (7) when clamping and unclamping a workpiece (10), an electronic rotary encoder (101) in a stationary arrangement is allocated to one of the components (53; 54) that is involved in the force transmission. Due to this embodiment, it is possible to configure the clamping device (1) with inherent rigidity, having neither play nor slip, as a result of which both the axial adjustment movements of the draw rod (7) and consequently the particular operating positions of the clamping jaws (6) of the power-operated chuck (5) can be used without restrictions. The machine tool (2) can be controlled without problems in this way with great accuracy without having to accept inaccuracies.

### REFERENCE TO PENDING PRIOR PATENT APPLICATION

This patent application claims benefit of European Patent Application No. 15 150 064.2, filed Jan. 5, 2015, which patent application is hereby incorporated herein by reference.

### FIELD OF THE INVENTION

The present invention relates to a clamping device, especially for machine tools, that are for example equipped with a power-operated chuck for holding a workpiece and the clamping jaws of which can be adjusted using the clamping device by means of an axially moveable draw rod as the actuating element, in which the clamping device possesses an electric drive motor with a changeover function for triggering clamping movements, a motion converter for converting the adjustment movements of the rotor shaft of the drive motor into the axial adjustment movements of the draw rod required for actuating the clamping jaws as well as a force accumulator for maintaining the clamping force, which comprises pre-stressed spring packs supported on an adjusting element of the motion converter that is configured as a hollow shaft and is provided with a projection projecting radially outward.

### BACKGROUND OF THE INVENTION

A clamping device of this kind is disclosed in EP 2 548 681 A1. In this embodiment, the movement converter has several planetary roller spindles as transmission elements which have a certain amount of slip due to their angled position in the thread turns provided in the draw rod and a hollow shaft in each case, depending on the pitch angle of the thread. This is detrimental because the draw rod thus occupies a different position on each rotation of the hollow shaft. The exact location of the draw rod and thus of the clamping jaws consequently cannot be determined by means of a travel sensor.

In addition, there is an idle movement in each change of direction between clamping and unclamping of a workpiece, which also means it is not possible to determine the axial location of the draw rod.

Furthermore, in this clamping device, it is a disadvantage that the cup springs used in the spring packs of the force accumulator only have a short spring travel, which is not suitable for providing satisfactory control of the machine tool. Also, a change in the clamping force of the power-operated chuck using the cup springs is only possible to an inadequate extent.

The clamping device of prior art consequently cannot be used in machine tools that should be controlled with the help of operating parameters resulting from the working sequences.

The task of the present invention is therefore to create a clamping device of the aforementioned type such that no slip occurs in the motion converter and that play-free adjustment movements are always provided which can thus be used for controlling the machine tool. Above all, the play-free rotary movements of one of the components of the clamping device should be able to be used as a measuring parameter for the corresponding adjustment movements of the draw rod in a simple manner. In addition, the force accumulator should have a large adjustment range that can also be used for controlling the machine tool, and its clamping force should be easily adaptable to changeable operating conditions without difficulties.

### SUMMARY OF THE INVENTION

In accordance with the present invention, this is achieved in a clamping device of the aforementioned type in that the clamping device is configured as a play and slip-free functional unit and that to determine the axial adjustment movements of the draw rod when clamping and unclamping a workpiece, an electronic rotary encoder in a stationary arrangement is allocated to a component of the clamping device that is involved in the force transmission.

For play-free configuration of the clamping device, it is necessary to connect the adjusting element of the motion converter to the actuation element in a direct, driveable connection by means of a pre-stressed ball screw drive; moreover, it is necessary to configure the spring packs of the force accumulator that act on one or both sides on the adjusting element equipped with a return channel for the balls of the ball screw drive by means of a plurality of coil compression springs arranged evenly around the circumference, and to use the motion converter and the force accumulator in a first housing in a fixed location, which is provided with a projection element or a carrier configured as a hollow shaft facing away from the power-operated chuck, on which transmission elements allocated to the drive motor are mounted, and are connected in a driveable connection to the adjusting element of the motion converter.

The transmission elements arranged on the projection element should in this case be able to be locked on the projection element or be in a positive-locking connection by means of a second housing that accommodates them, or a carrier that supports them.

The second housing or the carrier, for example, can be provided as a component of the clamping device interacting with the rotary encoder, in which case they are provided on an outer jacket surface with one or more barcodes or toothed profiles, in the rotational plane of which the sensor of the rotary encoder is arranged.

In accordance with a different embodiment, it is also possible for the rotary encoder to be allocated to the drive motor of the clamping device in that a cylindrical disk is arranged on its rotor shaft in a rotationally fixed arrangement, one or more barcodes or toothed profiles are attached to its outer jacket surface that interact with the sensor of the rotary encoder.

By means of the electronic rotary encoder, it is consequently possible in a simple way to register the speed of rotation, direction of rotation and angle of rotation of a component of the clamping device. Play and slip-free transmission is provided, as a result of which the particular operating status of the draw rod can be determined precisely, in particular during clamping or unclamping of a workpiece. By means of this measuring parameter, it is thus ensured that the machine tool can be controlled and monitored highly accurately.

It is also advantageous in this case for the coil compression springs of the force accumulator to be inserted in a one or two-part pressure piece in which the projection of the adjusting element of the motion converter engages and is supported in this in an axially rotating arrangement, in which case the coil compression springs of the force accumulator that can be inserted in holes preferably provided in the pressure piece on one or both sides of the projection of the adjusting element have a rectangular, preferably square, elliptical or circular cross sectional surface.

This embodiment of the force accumulator makes it possible to configure its clamping force for the maximum clamping force of the power-operated chuck when the pressure piece is completely equipped with coil compression springs, and by removing individual coil compression springs or using springs with a low spring force, the corresponding clamping force of the force accumulator can be adapted to specified operating conditions.

Furthermore, it is advantageous for the ball screw drive to be provided with lubricant from the interior of the first housing in a forced feed by means of adjusting movements of the adjusting element of the motion converter, for example through holes provided in it.

It is also appropriate for the pressure piece to be provided with a signal transmitter that passes through the first housing, which interacts with a travel sensor in order to determine the particular clamping force of the force accumulator. In addition, the draw rod can be equipped with a signal transmitter configured as a stroke ring in the area between the machine tool and the first housing of the clamping device, in which case the signal transmitter interacts with a further travel sensor to determine the particular position of the draw rod during working procedures. By means of these signal transmitters, it is thus possible to pick up measurement parameters that allow reliable control of the machine tool.

Moreover, it is advantageous for the transmission elements allocated to the drive motor of the clamping device to be inserted in the second housing which is connected in a fluid-tight connection to the first housing, or for them to be supported on the carrier.

The transmission elements should be configured as a play-free double-planetary gear unit with different numbers of teeth on the planetary gears in order to create step-down or step-up ratios, in which case the planetary gears must be mounted in a rotating arrangement on a pin supported in the second housing and must engage in sun gears, of which one sun gear is firmly connected to the projection element and the other sun gear interacts with an intermediate gear that engages in the intermediate elements.

The transmission elements can also be configured by a gear rim provided on the carrier. The transmission elements in this case should be able to be connected to the adjusting element of the motion converter by means of one or more intermediate elements passed through the adjacent end wall of the first housing.

Each of the intermediate elements can be configured as eccentrically mounted double gears which are mounted in a rotating arrangement on a pin supported on the first and/or second housing, and are in a driving connection with the sun gear of one of the gear sets of the planetary gear unit or with the gear rim provided on the carrier or the adjusting element of the motion converter.

In order to lock the second housing or the carrier with the projection, it is possible to provide a sliding sleeve that is axially adjusted on it and mounted in a non-rotating arrangement, which can be activated by means of a servo device and/or the force of springs.

Moreover, the draw rod should be mounted in the projection element of the first housing with its end facing away from the power-operated chuck in an axially adjustable arrangement, and the first and the second housings should be filled completely or partially with oil or a lubricant.

If a clamping device is configured in accordance with the present invention and has a plurality of design features that are also partially known, it is possible to configure the clamping device with inherent rigidity, having neither play nor slip, as a result of which both the axial adjustment movements of the draw rod and consequently the particular operating positions of the clamping jaws of the power-operated chuck can be used without restrictions. The machine tool can consequently be controlled without problems using the measuring parameters ascertained in this way, and it can be controlled with great accuracy without having to accept inaccuracies. Above all, it is an advantage in this case that no slip or play exists between the rotating components of the clamping device, as a result of which the position of the draw rod can be measured without difficulties by means of the rotary encoder outside the clamping device, thereby guaranteeing monitoring and control during operation.

The rigid connection between the components involved in the force transmission which is achieved in spite of the simple configuration and low complexity of design thereby guarantees a correct correlation of the particular operating data of the clamping device, and consequently accurate positioning of the machine tool. There is no need to undertake differential measurements in this case, because no slip occurs and there is no play either. Furthermore, the particular measurement values can be ascertained without difficulties outside the clamping device, as a result of which trouble-free operation is guaranteed over a long operating period.

Furthermore, it is an advantage that the preload of the force accumulator can be adapted without difficulties to the particular requirements by the plurality of coil compression springs which can have a high clamping force. And, because the coil compression springs have a relatively long spring travel that can be used as a measuring parameters for the clamping force, it is possible to determine the particular clamping force applied in a reliable manner.

In the clamping device configured in accordance with the proposal, it is thus possible to ascertain the precise clamping force and the location of the draw rod at any time, as a result of which this operating data enables the machine tool to be controlled without any incorrect measurements. In addition, the interior of the functional unit can be sealed and filled with oil or a lubricant, consequently guaranteeing trouble-free operation over a long period with a high degree of operational reliability. Also, operating the clamping device requires little energy, because during operation the components involved in the force transmission are clamped against one another so the drive motor does not have to absorb any energy. The clamping device can thus be used in a wide range of applications in an economic manner.

### BRIEF DESCRIPTION OF THE DRAWINGS

The drawing shows two sample embodiments of the clamping device configured in accordance with the present invention, the details of which are explained below. In the drawing,

FIG. 1 shows the clamping device in an axial section in the clamping position, thus during a working procedure,

FIG. 2 shows a modification of the clamping device in accordance with FIG. 1, also in the locked operating condition,

FIG. 3 shows a section through the clamping device in accordance with FIG. 1, in a magnified view with a decoupled drive motor and a different kind of locking mechanism, as well as

FIG. 4 shows the force accumulator of the clamping device in a magnified perspective view.

### DETAILED DESCRIPTION OF THE INVENTION

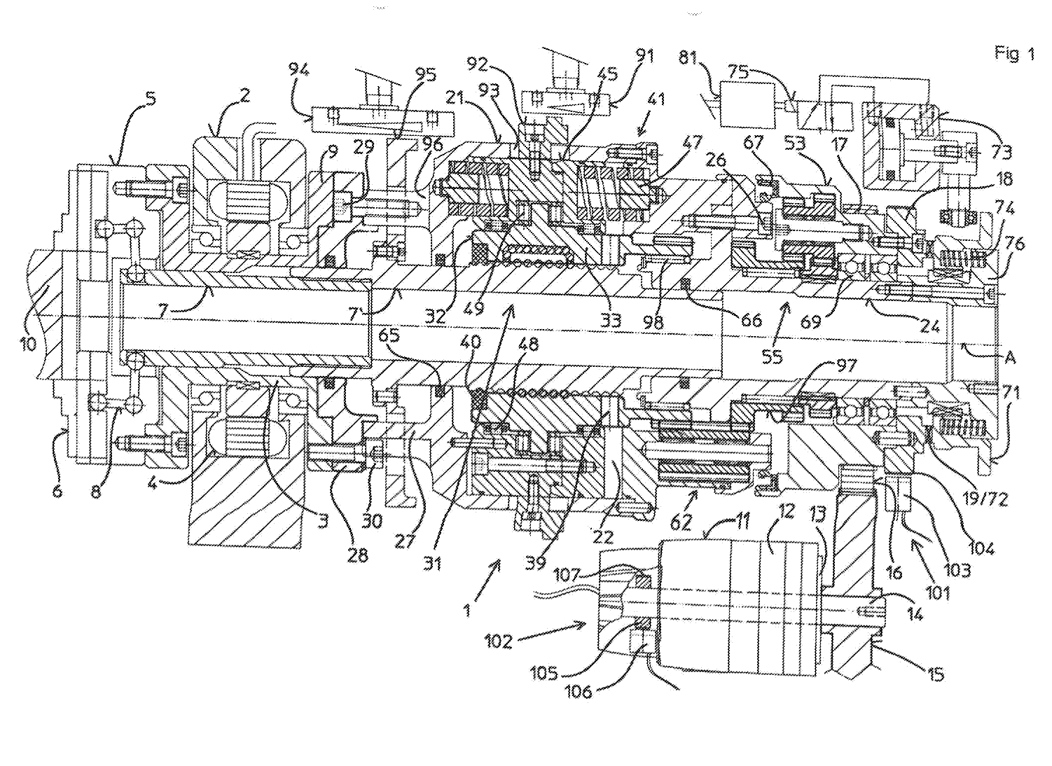

The clamping device illustrated in FIGS. 1 to 3 and identified by 1 is used for actuating a power-operated chuck 5 arranged on a machine tool 2, by means of the radially adjustable clamping jaws 6 of which a workpiece 10 to be machined can be clamped in the power-operated chuck 5. The clamping jaws 6 of the power-operated chuck 5 in this case can be actuated via relay levers 8 by an axially adjustable, two-part draw rod 7, 7′ that is in a driven connection with an electric drive motor 11 that has a changeover function by means of a motion converter 31. The rotational adjustment movements of the drive motor 11 are converted into axial adjustment movements of the draw rod 7, 7′ by means of the motion converter 31.

The drive motor 11 consists of a stator 12 arranged parallel to the longitudinal axis A of the clamping device 1 in a stationary location and a rotor 13 which has a gear 15 attached to its rotor shafts 14 in a rotationally fixed arrangement, by means of which a toothed belt 16 is guided which interacts with a geared drive wheel 17 allocated to the clamping device 11. However, the drive motor 11 can also be arranged at right angles to the longitudinal axis A of the clamping device and is in a driving connection with the drive wheel 17 via bevel gears.

The clamping device 1 has a housing 21 in which the motion converter 31 and a force accumulator 41 are accommodated. On the side facing the machine tool 2, the housing 21 is provided with a projecting web 27 to which a flange 28 is attached by means of screws 29. Additional screws 30 attach the flange 28 to another flange 9 that is formed on the machine spindle 3. An electric motor 4 acts on the machine spindle 3, by means of which the machine tool 2 can be driven.

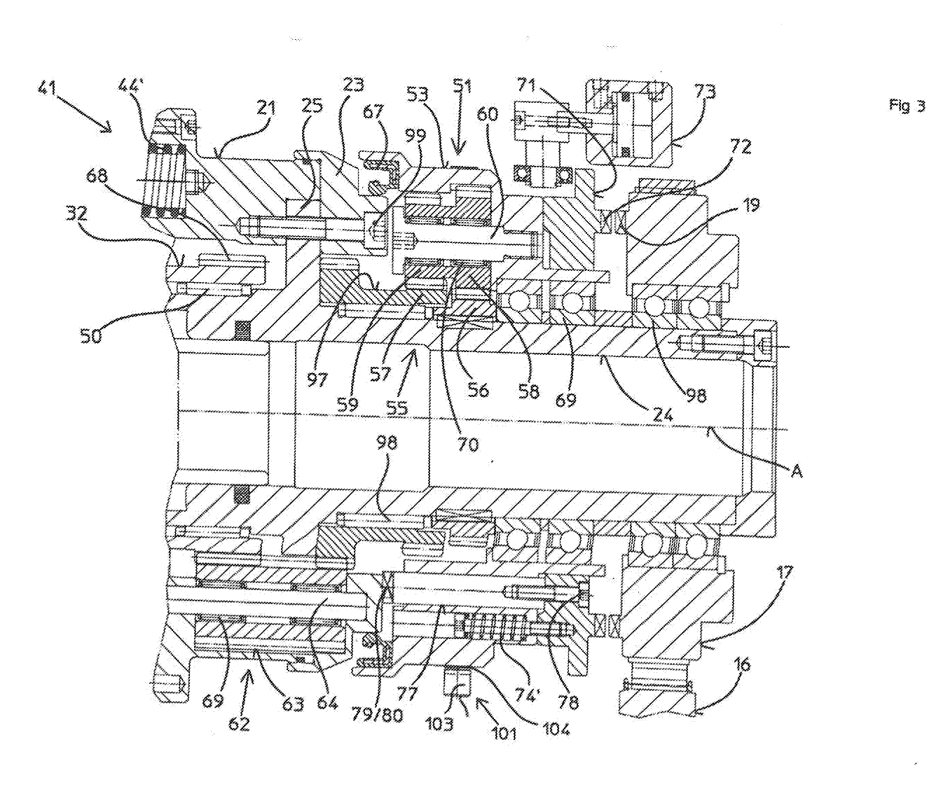

In the embodiment shown in FIG. 1, on the side facing away from the power-operated chuck 5, a projection element 24 is attached to the housing 21 and carries a second housing 53. The second housing 53 accommodates a double-planetary gear unit 55 as the transmission element 51, which comprises both sun gears 56 and 57 as well as several planetary gears 58 and 59 that engage in the sun gears 56 and 57. In this case, as shown in detail in FIG. 3, each of the planetary gears 58 and 59 is mounted on an anti-friction bearing with 70 on a pin 60 that is supported in the housing 53. The planetary gears 58 engage with the sun gear 56 which is firmly connected to the projection element 24. The planetary gears 59, on the other hand, engage in an intermediate gear 97 which is in a driving connection with intermediate elements 62. The double planetary gear unit 55 thus forms the transmission element 51 by means of which the drive energy taken from the drive motor 11 can be delivered to the motion converter 31 via the intermediate elements 62, thereby causing a step-down ratio to be applied to the input rotation because the numbers of teeth on the planetary gears 58 and 59 are different.

In this case, the intermediate elements 62 consist of double-toothed gears 63 that are mounted on anti-friction bearings 69 so as to rotate on pins 64. The intermediate elements 62 pass through the end wall 23 of the first housing 21 as well as a flange 25 of the projection element 24, with the effect that the double-toothed gears 63 can engage in gearing 69 provided on the adjusting element 32 of the motion converter 31, as a result of which the gearing 68 can be placed in a driving connection with the drive motor 11 for actuating the power-operated chuck 5.

The motion converter 31 has the adjusting element 32 configured as a hollow shaft 33, which is provided with a projection 34 projecting radially outwards, and has a pre-stressed ball screw drive 35 worked into it. A channel 37 is provided in order to return the balls 36 that interact with a thread 38 worked into the draw rod 7′. Anti-friction bearings 50 support the adjusting element 32 on the projection element 24 in a rotating arrangement.

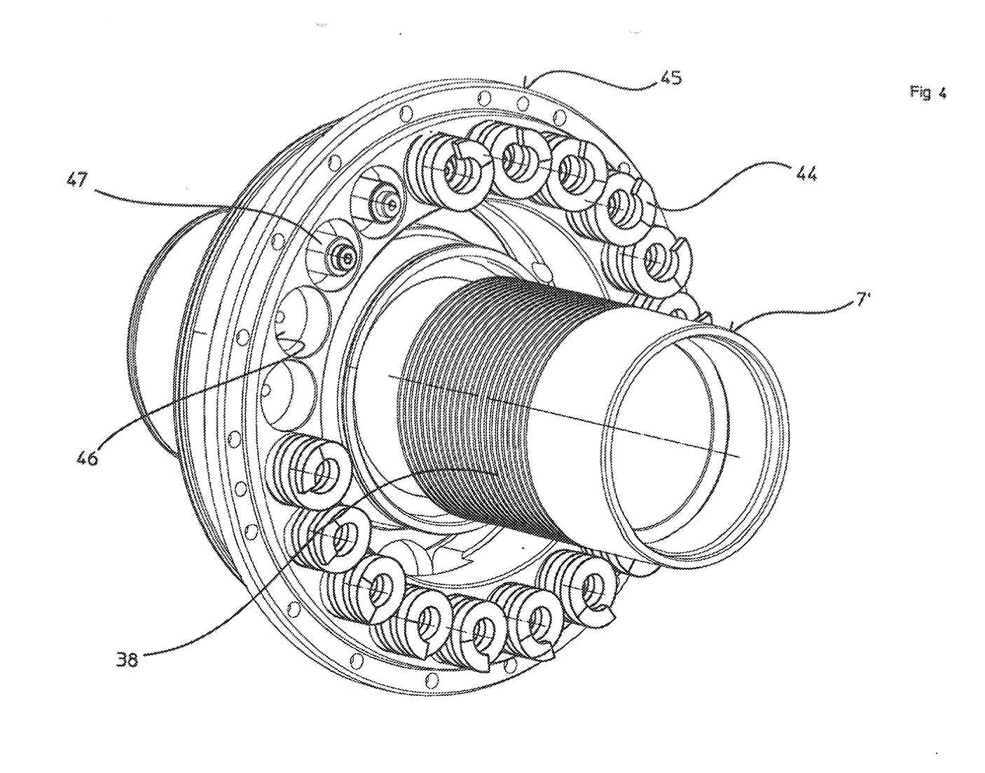

The force accumulator 41 has a plurality of spring packs 42 and 43 that are inserted in a pressure piece 45. Furthermore, as can be seen in particular in FIG. 4, a plurality of holes 46 are worked into the pressure piece 45, and are distributed evenly around the circumference; these holes 46 have the coil compression springs 44 or 44′ inserted in them, which have a square or circular cross-section and are guided on pins 47. Anti-friction bearings 48 and 49 support the pressure piece 45 in the axial and radial direction on the adjusting element 32 of the motion converter 31.

This configuration makes it possible to arrange a large number of coil compression springs 44 or 44′ in the pressure piece 45, and due to their cross-sectional shape these springs have a high spring force. Also, the coil compression springs 44 or 44′ can easily be exchanged or partially removed within a short period of time, thereby allowing the force of the force accumulator 41 to be adapted to the particular required clamping force of the power-operated chuck 5 without difficulty. Also, if individual coil compression springs 44 or 44′ are damaged for any reason and needed to be replaced quickly this means the clamping force of the force accumulator 41 is not significantly impaired.

Furthermore, because the coil compression springs 44 or 44′ also have a large spring travel, it is possible to use them for precise control of the machine tool 2. To make this possible, a signal transmitter 92 is attached to the pressure piece 45 and passes through an opening 93 provided in the first housing 21, interacting with a travel sensor 91 in a fixed location. In this way, the force prevailing in the force accumulator 41 can easily be determined.

Also, the particular location of the clamping jaws 6 of the power-operated chuck 5 can be determined in a similar manner during a working procedure. To do this, a stroke ring 95 is attached as a signal transmitter on the draw rod 7 in the area between the first housing 21 and the machine tool 2, and also interacts with a travel sensor 94. In this case, the stroke ring 95 passes through the web 27 that is provided with an opening 96, by means of which the first housing 21 is fixed to the flange 28 that is attached to the flange 9 formed on the machine spindle 3.

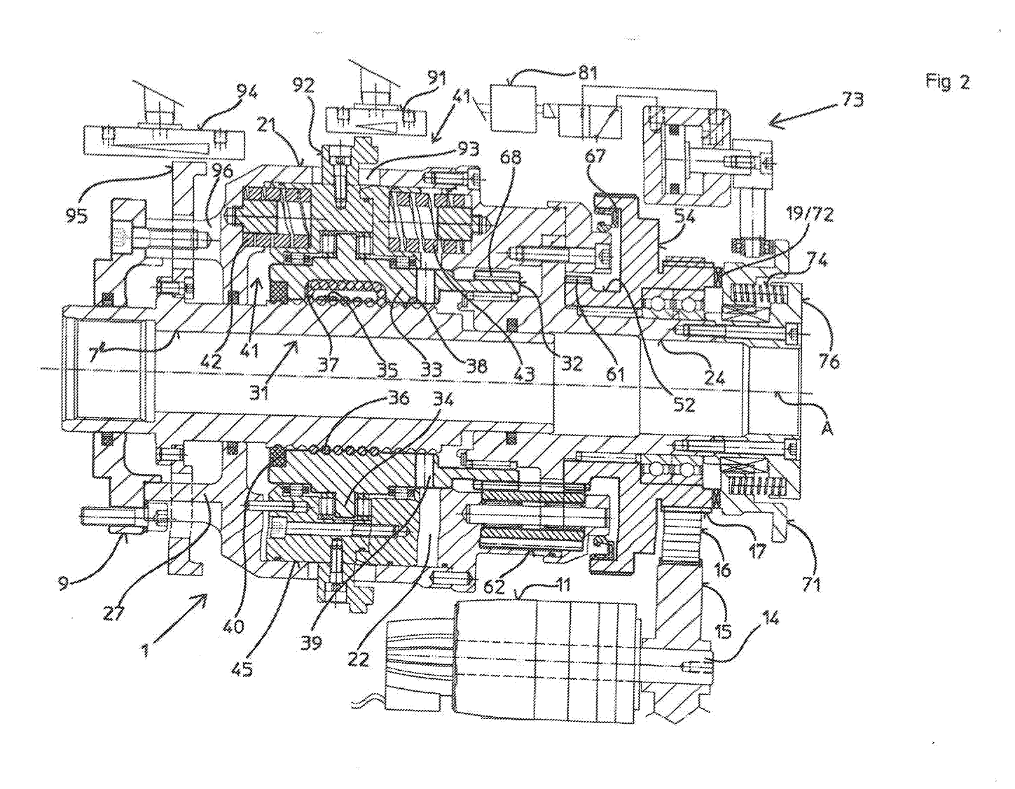

In the operating position shown in FIGS. 1 and 2, corresponding to a working position in which the workpiece 10 clamped in the power-operated chuck 5 is machined, the projection element 24 is locked with the first housing 21. This is done using a sliding sleeve 71 that is provided with gearing at 72 on its end face that faces towards the projection element 24, with the gearing 72 engaging in gearing 19 attached to a flange 18 that is itself connected to the second housing 53 in a rotationally fixed arrangement in this operating condition. The second housing 53 is thus linked to the projection element 24 on which the sliding sleeve 71 is supported in a rotationally fixed arrangement but is axially movable, meaning that a rigid connection is established between all components involved in the force transmission.

The sliding sleeve 71 is able to be operated automatically by the force of springs 74 that are supported against the sliding sleeve 71 as well as against a flange 76 attached to the projection element 24. However, a servo device 73 is provided for disengaging the sliding sleeve 71 and operates against the force of the springs 74 on the sliding sleeve 71. The sliding sleeve 71 can be controlled by means of a control unit 81 to which the travel sensors 91 and 94 are also connected. In order for the workpiece 10 to be clamped or unclamped, it is consequently possible to release the locking of the gearings 19 and 72, while the drive motor 11 can supply energy to the motion converter 31 by means of the second housing 53, the planetary gear unit 55 and the intermediate elements 62, in order to act on the draw rod 7, 7′ and thus on the clamping jaws 6 of the power-operated chuck 5 by means of the adjusting element 32 of the movement converter 31 in a corresponding manner.

In order to allow the ball screw drive 35 of the motion converter 31 to be supplied adequately with lubricant at all times, the interior 22 of the housing 21 filled with a lubricant is sealed towards the outside by means of seals 65 and 66.

In addition, the bearings 69 that carry the second housing 53 which, in addition, is sealed against the first housing 21 by means of a seal 67, are configured with a fluid-tight seal. And, because several radial holes 39 are worked into the adjusting element 32 of the motion converter 31, each adjustment procedure towards the right of the adjusting element 31 and of the pressure piece 45 in a driving connection with the adjusting element 32 causes lubricant to be supplied to the transmission element 51 which is sealed on one side by a seal 40, with the effect that the ball screw drive 35 is always adequately lubricated.

In the embodiment shown in FIG. 3, the drive motor 11 is decoupled from the clamping device 1. In this case, the gearing 72 attached to the sliding sleeve 71 is not engaged with the gearing 19 provided on the drive gear 17 that is supported on the projection element 24 by means of bearings 98. The sliding sleeve 71 which can in turn be actuated by means of the servo device 73 is supported on the end wall 23 of the first housing 21 by means of pins 77, however, with gearing 79 and 80 provided in this housing 21 engaging with one another. Screws 78 attach the pins 77 to the sliding sleeve 71, and they are thus guided in the second housing 53.

In the embodiment shown in FIG. 2, the drive gear 17 and also the transmission elements 52 configured in the form of a gear rim 61 are attached to a T-shaped carrier 54. The drive energy for carrying out adjusting movements of the clamping jaws 6 of the power-operated chuck 5 is thus supplied to the motion converter 31 by means of the carrier 54 and, in turn, by means of intermediate elements 62, and via the ball screw drive 35 of the motion converter 31, to the draw rod 7, 7′ and from this to the clamping jaws 6 of the power-operated chuck 5. In this case, a gear rim 61 attached to the carrier 54 is provided as the transmission element 52.

The play and slip-free configuration of the motion converter 31, of the force accumulator 41 and of the other components of the clamping device 1 involved in the force transmission makes it possible to use the adjusting movements of rotating parts for exact control and monitoring of the machine tool 2. To make this possible, the embodiment shown in FIGS. 1 and 2 are each provided with an electronic rotary encoder 101 which consists of a sensor 103 and a one or multiple-part barcode 104 attached to an outer jacket surface of the second housing 53 or of the carrier 54. Instead of the barcode 104, it is also possible to provide a correspondingly configured gearing.

By means of the rotary encoder 101, it is thus not only possible to determine the rotation speeds and the particular rotation direction of the second housing 53 or of the carrier 54, but also slight changes in the rotation angle of these components. These measuring parameters, which can also be sent to the control unit 81, correspond precisely to the changes in the draw rod 7, 7′ or the power-operated chuck 5, because the design embodiment of the clamping device 1 means that no slip or play has to be accepted, as a result of which the machine tool 2 can be controlled with very great accuracy.

For the same purpose, the drive motor 11 can also be equipped with an electronic rotary encoder 102. For this purpose, only a disc 105 needs to be attached to its rotor shaft 14, and the disc must be provided with a corresponding barcode 107 on its outer jacket surface. The measurement results are to be sent to the control unit in turn by means of a sensor 106.

1. A clamping device (1), especially for machine tools (2), that are for example equipped with a power-operated chuck (5) for holding a workpiece (10) and clamping jaws (6) which can be adjusted using the clamping device (1) by means of an axially moveable draw rod (7, 7′) as an actuating element, in which the clamping device (1) possesses an electric drive motor (11) with a changeover function for triggering clamping movements, a motion converter (31) for converting the adjustment movements of a rotor shaft (14) of a drive motor (11) into axial adjustment movements of the draw rod (7, 7′) required for actuating the clamping jaws (6) as well as a force accumulator (41) for maintaining the clamping force, which comprises pre-stressed spring packs (42, 43) supported on an adjusting element (32) of the motion converter (31) that is configured as a hollow shaft (33) and is provided with a projection (34) projecting radially outward.
characterised in that,
the clamping device (1) is configured as a play and slip-free functional unit and that to determine the axial adjustment movements of the draw rod (7, 7′) when clamping and unclamping a workpiece (10), an electronic rotary encoder (101; 102) in a stationary arrangement is allocated to one of the components (53; 54) of the clamping device (1) that is involved in the force transmission.

2. The clamping device in accordance with claim 1,
characterised in that
for play-free configuration of the clamping device (1), it is necessary to connect the adjusting element (32) of the motion converter (31) to the axially moveable draw rod (7, 7′) in a direct, driveable connection by means of a pre-stressed ball screw drive (35); that the spring packs (43) of the force accumulator (41) that act on one or both sides on the adjusting element (32) equipped with a return channel (37) for balls (36) of a ball screw drive (35) by means of a plurality of coil compression springs (44, 44′) arranged evenly around the circumference, that the motion converter (31) and the force accumulator (41) are inserted in a first housing (21) in a fixed location, which is provided with a projection element (24) or a carrier (54) configured as a hollow shaft facing away from the power-operated chuck (5), on which transmission elements (51, 52) allocated to the drive motor (11) are mounted, and are connected in a driveable connection to the adjusting element (32) of the motion converter (31).

3. The clamping device in accordance with claim 2,
characterised in that
the transmission elements (51, 52) arranged on the projection element (24) should in this case be able to be locked on the projection element (24) or be in a positive-locking connection by means of a second housing (53) that accommodates them, or a carrier (54) that supports them.

4. The clamping device in accordance with claim 3,
characterised in that
the second housing (53) or the carrier (54), for example, is provided as components of the clamping device (1) interacting with the rotary encoder (101), in which case they are provided on an outer jacket surface with one or more barcodes (104) or toothed profiles, in the rotational plane of which the sensor (103) of the rotary encoder (101) is arranged.

5. The clamping device in accordance with claim 1,
characterised in that
the rotary encoder (102) is allocated to the drive motor (11) of the clamping device (1) in that a cylindrical disk (105) is arranged on its rotor shaft (14) in a rotationally fixed arrangement, one or more barcodes (107) or toothed profiles are attached to its outer jacket surface that interact with a sensor (103) of the rotary encoder (102).

6. The clamping device in accordance with claim 1,
characterised in that
coil compression springs (44) of the force accumulator (41) are inserted in a one or two-part pressure piece (45) in which the projection (34) of the adjusting element (32) of the motion converter (31) engages and is supported in this in an axially rotating arrangement.

7. The clamping device in accordance with claim 6,
characterised in that
the coil compression springs (44, 44′) of the force accumulator (41) can be inserted in holes (46) preferably provided in the pressure piece (45) on one or both sides of the projection (34) of the adjusting element (32) and that the coil compression springs (44, 44′) have a rectangular, preferably square, elliptical or circular cross sectional surface.

8. The clamping device in accordance with claim 2,
characterised in that
the ball screw drive (35) is provided with lubricant from an interior (22) of the first housing (21) in a forced feed by means of adjusting movements of the adjusting element (32), for example through holes (39) provided in it.

9. The clamping device in accordance with claim 2,
characterised in that
a pressure piece (45) is provided with a signal transmitter (92) that passes through the first housing (21), which interacts with a travel sensor (91) in order to determine the particular clamping force of the force accumulator (41).

10. The clamping device in accordance with claim 1,
characterised in that
the draw rod (7, 7′) is equipped with a signal transmitter (95) configured as a stroke ring in the area between the machine tool (2) and a first housing (21) of the clamping device (1), in which case the signal transmitter (95) interacts with a travel sensor (94) to determine the particular position of the draw rod (7, 7′).

11. The clamping device in accordance with claim 2,
characterised in that
transmission elements (51, 52) allocated to the drive motor (11) of the clamping device (1) are inserted in a second housing (53) which is connected in a fluid-tight connection to the first housing (21), or for them to be supported on the carrier (54).

12. The clamping device in accordance with claim 11,
characterised in that
the transmission elements (51) are configured as a play-free double-planetary gear unit (55) with different numbers of teeth on the planetary gears (58, 59), that the planetary gears (58, 59) are mounted in a rotating arrangement on a pin (60) supported in a second housing (53) and engage in sun gears (56, 57), of which one sun gear (56) is firmly connected to the projection element (24) and the other sun gear (57) interacts with an intermediate gear (97) that engages in intermediate elements (62).

13. The clamping device in accordance with claim 11,
characterised in that
the transmission elements (52) are configured by a gear rim (61) provided on the carrier (54).

14. The clamping device in accordance with claim 2,
characterised in that
the transmission elements (51, 52) are connected to the adjusting element (32) of the motion converter (31) by means of one or more intermediate elements (62) passed through the adjacent end wall of the first housing (21).

15. The clamping device in accordance with claim 14,
characterised in that
each of the intermediate elements (62) is configured as eccentrically mounted double gears (63) which are mounted in a rotating arrangement on a pin (64) supported on the first and/or second housing (21 or 53), and are in a driving connection with a sun gear (59) of one of the gear sets of a planetary gear unit (55) or with a gear rim (61) provided on the carrier (54) or the adjusting element (32) of the motion converter (31).

16. The clamping device in accordance with claim 3,
characterised in that
in order to lock the second housing (53) or the carrier (54) with the projection element (24), a sliding sleeve (71) is provided that is axially adjusted on it and mounted in a non-rotating arrangement, which can be activated by means of a servo device (73) and/or the force of springs (74, 74′).

17. The clamping device in accordance claim 2,
characterised in that
the draw rod (7, 7′) is mounted in the projection element (24) of the first housing (21) with its end facing away from the power-operated chuck (5) in an axially adjustable arrangement.

18. The clamping device in accordance with claim 3,
characterised in that
the first and the second housings (21, 53) should be filled completely or partially with oil or a lubricant.
